(19) United States
(12) Patent Application Publication
(10) Pub. No.: US 2024/0146132 A1
(43) Pub. Date: May 2, 2024

(54) AXIAL FLUX ELECTRIC MOTOR FOR A VEHICLE HAVING ROTOR SEGMENT SUPPORT MEMBER INCLUDING A NON-UNIFORM CROSS-SECTION

(71) Applicant: GM Global Technology Operations LLC, Detroit, MI (US)

(72) Inventors: Jian Yao, Shanghai (CN); Chengwu Duan, Shanghai (CN); Vincent Fedida, Shanghai (CN)

(21) Appl. No.: 17/987,186

(22) Filed: Nov. 15, 2022

(30) Foreign Application Priority Data
Oct. 27, 2022 (CN) 202211326690.0

(51) Int. Cl. H02K 1/28; B60L 50/10; H02K 1/2786

(52) U.S. Cl. CPC H02K 1/28; B60L 50/10; H02K 1/2786

(57) ABSTRACT

A rotor segment support member includes an annular body having an outer edge, an inner edge defining an opening, a first surface, and a second surface opposite the first surface. The rotor segment support member has a circumferential axis extending about the annular body and a radial axis extending between the outer edge and a center of the opening through the inner edge. The annular body has a non-uniform cross-section extending along one of the circumferential axis and the radial axis.

### CROSS-REFERENCE TO RELATED APPLICATIONS

This application claims priority to Chinese Patent Application No. 202211326690.0, filed Oct. 27, 2022, the contents of which are incorporated by reference herein in their entirety.

### INTRODUCTION

The subject disclosure relates to the art of axial flux electric motors and, more particularly, to an axial flux electric motor having a rotor segment support member including a non-uniform cross-section.

Axial flux electric motors include stators that are fixedly mounted in a housing and a rotor that is axially aligned with the stator and rotatably supported in the housing. In some cases, a pair of rotors may flank a centrally mounted stator. In other cases, a pair of stators may flank a rotatable rotor. The rotor includes a support member to which is bonded a plurality of permanent magnet (PM) members. The PM members rotate relative to the stator to produce an electric current.

The rotor support is formed from a material that supports magnetic flux produced by the rotor. Given the need to support rotational loads, the rotor is formed from a metal having a uniform cross-section. In addition to supporting operational loads, the uniform cross-section provides a flow path for magnetic flux to pass between PM members. While effective, the uniform cross-section creates additional mass that may lead to accelerated wear. Further, the additional mass requires extra work to set into motion. Accordingly, it is desirable to provide a PM member support that provides a magnetic flux flow path without generating a weight penalty that will require additional work input into the motor.

### SUMMARY

Disclosed, in accordance with a non-limiting example, is a rotor segment support member including an annular body having an outer edge, an inner edge defining an opening, a first surface, and a second surface opposite the first surface. The rotor segment support member has a circumferential axis extending about the annular body and a radial axis extending between the outer edge and a center of the opening through the inner edge. The annular body has a non-uniform cross-section extending along one of the circumferential axis and the radial axis.

In addition to one or more of the features described herein the first surface extends substantially perpendicularly relative to the outer edge and the inner edge.

In addition to one or more of the features described herein a plurality of permanent magnet (PM) members is arrayed about the first surface.

In addition to one or more of the features described herein the outer edge includes a first thickness and the inner edge includes a second thickness that is less than the first thickness.

In addition to one or more of the features described herein the second side tapers from the outer edge toward the inner edge.

In addition to one or more of the features described herein a recess is formed in the second surface, the recess extending between the outer edge and the inner edge.

In addition to one or more of the features described herein the recess includes a first width at the outer edge and a second width at the inner edge, the second width being smaller than the first width.

In addition to one or more of the features described herein the recess includes a first depth at the outer edge and a second depth at the inner edge, the first depth being greater than the second depth.

In addition to one or more of the features described herein the recess is formed in the second surface opposite each of the plurality of PM members.

In addition to one or more of the features described herein the non-uniform cross-section extends along each of the circumferential axis and the radial axis.

A vehicle, in accordance with a non-limiting example, includes a body defining a passenger compartment, an axial flux electric motor is supported in the body. The axial flux electric motor includes a housing, a stator fixedly mounted in the housing, and a rotor rotatably supported in the housing axially adjacent to the stator. The rotor includes a rotor segment support member including an annular body having an outer edge, an inner edge defining an opening, a first surface, and a second surface opposite the first surface. The rotor segment support member has a circumferential axis extending about the annular body and a radial axis extending between the outer edge and a center of the opening through the inner edge. The annular body has a non-uniform cross-section extending along one of the circumferential axis and the radial axis.

In addition to one or more of the features described herein the first surface extends substantially perpendicularly relative to the outer edge and the inner edge.

In addition to one or more of the features described herein a plurality of permanent magnet (PM) members is arrayed about the first surface.

In addition to one or more of the features described herein the outer edge includes a first thickness and the inner edge includes a second thickness that is less than the first thickness.

In addition to one or more of the features described herein the second side tapers from the outer edge toward the inner edge.

In addition to one or more of the features described herein a recess is formed in the second surface, the recess extending between the outer edge and the inner edge.

In addition to one or more of the features described herein the recess includes a first width at the outer edge and a second width at the inner edge, the second width being smaller than the first width.

In addition to one or more of the features described herein the recess includes a first depth at the outer edge and a second depth at the inner edge, the first depth being greater than the second depth.

In addition to one or more of the features described herein the recess is formed in the second surface opposite each of the plurality of PM members.

In addition to one or more of the features described herein the non-uniform cross-section extends along each of the circumferential axis and the radial axis.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle including an axial flux electric motor having a rotor having a rotor segment support member including a non-uniform cross-section, in accordance with a non-limiting example;

FIG. 2 is a partial cross-sectional view of an axial-flux motor including a rotor having a rotor segment support member including a non-uniform cross-section, in accordance with a non-limiting example;

FIG. 3 is a cross-sectional side view of a stator flanked by first and second rotors each having a rotor segment support member having a non-uniform cross-section, in accordance with a non-limiting example;

FIG. 4 is a perspective view of the first rotor of FIG. 3, in accordance with a non-limiting example;

FIG. 5 is a perspective view of a rotor including a rotor segment support member having a non-uniform cross-section, in accordance with another non-limiting example; and

FIG. 6 is a partial perspective view of the rotor segment support member of FIG. 5, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

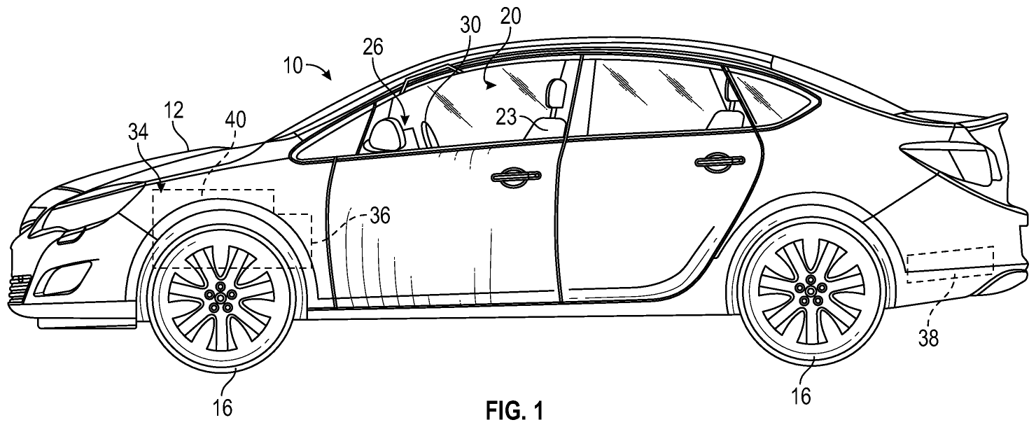

A vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. That is, changing a position of two of the plurality of wheels 16 relative to body 12 will cause vehicle 10 to change direction. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s).

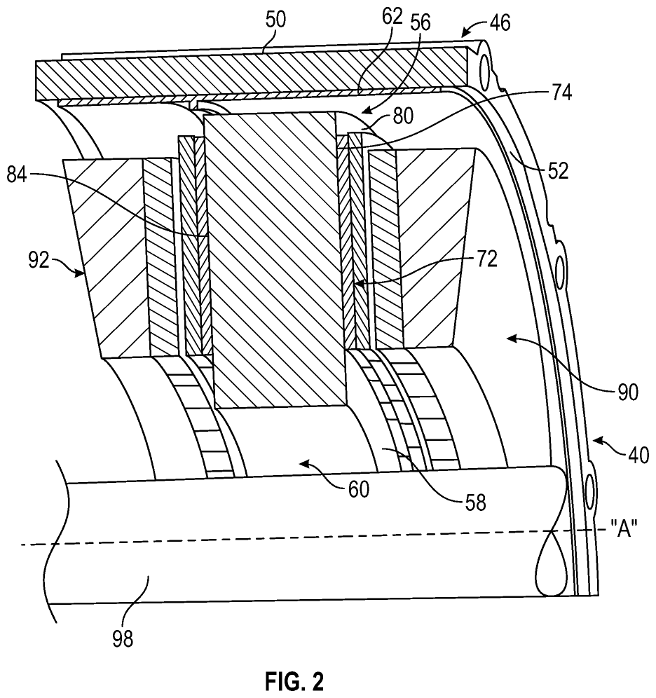

Vehicle 10 includes an electric motor 34 connected to a transmission 36 that provides power to one or more of the plurality of wheels 16. A rechargeable energy storage system (RESS) 38 provides power to electric motor 34. In a non-limiting example, electric motor 34 takes the form of an axial flux electric motor 40 having a housing 46 as shown in FIG. 2. Housing 46 includes an outer surface 50 and an inner surface 52.

In a non-limiting example, a stator 56 is fixedly mounted within housing 46. Stator 56 includes an inner annular support member 58 that defines a passage 60, and an outer annular member 62. A plurality of stator winding members, one of which is indicated at 72, is disposed between inner annular support member 58 and outer annular member 62. Each of the plurality of stator winding members includes a stator segment support member 74. The plurality of stator winding members 72 also includes a first axially facing surface 80 and a second axially facing surface 84. A first rotor 90 is arranged adjacent to first axially facing surface 80 and a second rotor 92 is arranged adjacent to second axially facing surface 84. First and second rotors 90 and 92 are supported for rotation with a shaft 98 having an axis of rotation “A” that passes through passage 60 of stator 56 and connects with transmission 36. Thus, first and second rotors 90 and 92 rotate relative to stator 56.

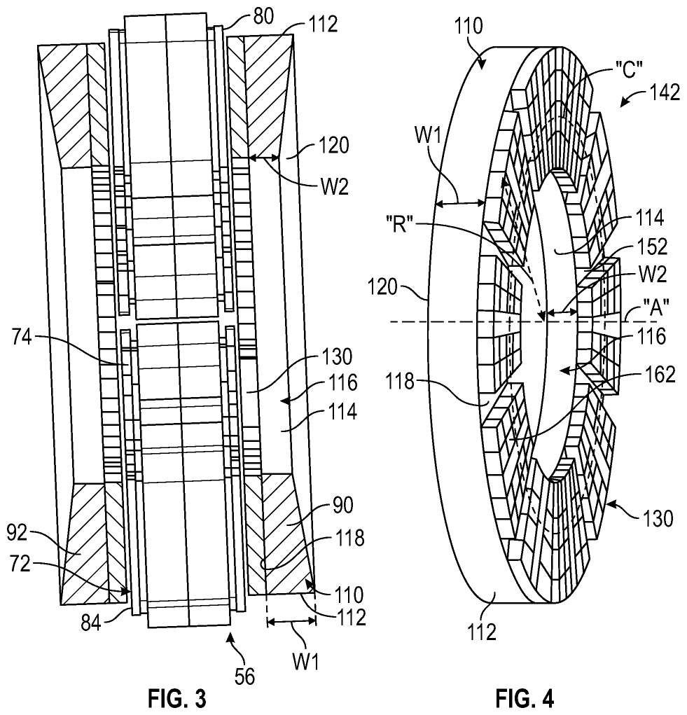

Reference will now follow to FIGS. 3 and 4 in describing first rotor 90 with an understanding that second rotor 92 includes similar structure. First rotor 90 includes an annular body 110 having an outer edge 112 and an inner edge 114 defining an opening 116. First rotor 90 includes a first surface 118 and a second surface 120 that is opposite first surface 118. First rotor 90 includes a circumferential axis “C” that extends about annular body 110 and a radial axis that extends from outer edge 112 through inner edge 114 to the axis of rotation “A” of shaft 98. First surface 118 extends substantially perpendicularly to inner edge 114 and outer edge 112 and supports a plurality of permanent magnet (PM) members 130.

In a non-limiting example, outer edge 112 includes a first width “1W” and inner edge 114 includes a second width “2W”. In a non-limiting example, the second width 2W is less than the first width 1W. In this manner, second surface 120 tapers along radial axis “R” forming a non-uniform cross-section for annular body 110. The non-uniform cross-section is designed to support flux passing between PM members 130 while, at the same time, reducing the overall weight of first rotor 90 in order to lower stresses on components of axial flux electric motor 40.

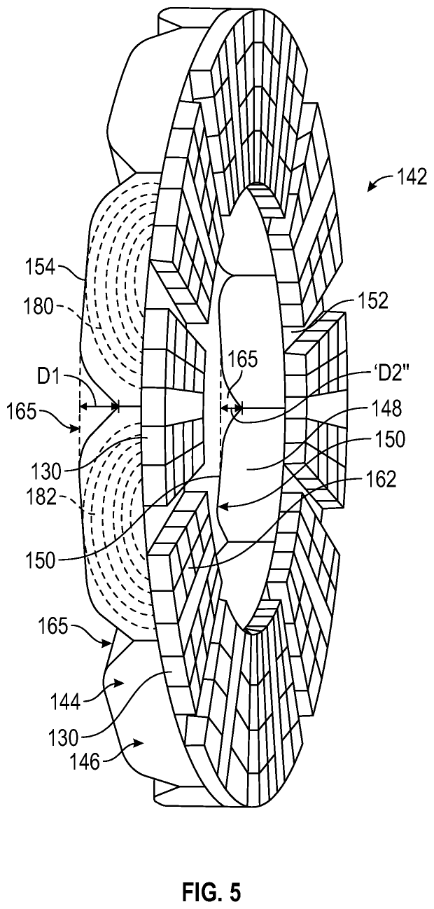

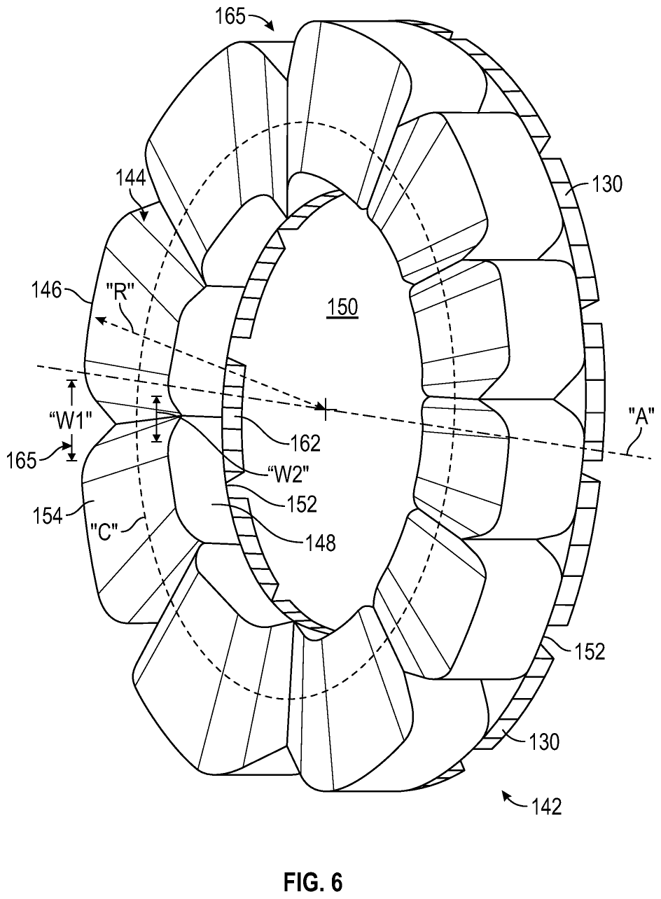

Reference will now follow to FIGS. 5 and 6 in describing a rotor 142 in accordance with a non-limiting example. Rotor 142 may be arranged axially adjacent to stator 56 in a manner similar to that described herein. Rotor 142 includes an annular body 144 having an outer edge 146 and an inner edge 148 defining an opening 150. Rotor 142 includes a first surface 152 and a second surface 154 that is opposite first surface 152. Rotor 142 includes a circumferential axis “C” that extends about annular body 144 and a radial axis “R” that extends from outer edge 146 through inner edge 148 to the axis of rotation “A” of shaft 98. First surface 152 extends substantially perpendicularly to inner edge 148 and outer edge 146 and supports a plurality of permanent magnet (PM) members 162.

In accordance with a non-limiting example, a plurality of recesses 165 extend across second surface 154 from outer edge 146 to inner edge 148, along radial axis “R”. Recesses 165 are centered on each PM member 130 and establish a non-uniform cross-section for annular body 144. Each recess 165 includes a first width 1W at outer edge 146 and a second width 2W at inner edge 148. Second width 2W is less than first width 1W such that recesses 165 taper from outer edge 146 to inner edge 148. In addition, each recess 165 includes a first depth 1D at outer edge 146 and a second depth 2D at inner edge 148. Second depth 2D is less than first depth 1D. As such, each recess 165 tapers in two dimensions.

As shown in FIG. 5, flux passes between PM members 130 in two directions. That is, a first flux portion 180 passes from one PM member 130 to an adjacent PM member 130 in a second direction. A second flux portion 182 passes from the one PM member 130 to another adjacent PM member 130 in a second direction. Thus, a portion of annular body 144 from second surface 154 directly adjacent each PM member 130 is an area of low flux density. Therefore, removing a portion of annular body 144 as shown in FIGS. 5 and 6 will not affect flux flow. As such, the non-uniform cross-section created by recesses 165 supports flux passing between PM members 130 while, at the same time, reducing the overall weight of rotor 142 in order to lower stresses on components of axial flux electric motor 40.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A rotor segment support member comprising:
an annular body having an outer edge, an inner edge defining an opening, a first surface, and a second surface opposite the first surface, the rotor segment support member having a circumferential axis extending about the annular body and a radial axis extending between the outer edge and a center of the opening through the inner edge, the annular body having a non-uniform cross-section extending along one of the circumferential axis and the radial axis.

2. The rotor segment support member according to claim 1, wherein the first surface extends substantially perpendicularly relative to the outer edge and the inner edge.

3. The rotor segment support member according to claim 2, further comprising a plurality of permanent magnet (PM) members arrayed about the first surface.

4. The rotor segment support member according to claim 3, wherein the outer edge includes a first thickness and the inner edge includes a second thickness that is less than the first thickness.

5. The rotor segment support member according to claim 4, wherein the second surface tapers from the outer edge toward the inner edge.

6. The rotor segment support member according to claim 3, further comprising a recess formed in the second surface, the recess extending between the outer edge and the inner edge.

7. The rotor segment support member according to claim 6, wherein the recess includes a first width at the outer edge and a second width at the inner edge, the second width being smaller than the first width.

8. The rotor segment support member according to claim 7, wherein the recess includes a first depth at the outer edge and a second depth at the inner edge, the first depth being greater than the second depth.

9. The rotor segment support member according to claim 7, wherein the recess is formed in the second surface opposite each of the plurality of PM members.

10. The rotor segment support member according to claim 1, wherein the non-uniform cross-section extends along each of the circumferential axis and the radial axis.

11. A vehicle comprising:
a body defining a passenger compartment;
an axial flux electric motor supported in the body, the axial flux electric motor including:
a housing
a stator fixedly mounted in the housing; and
a rotor rotatably supported in the housing axially adjacent to the stator, the rotor including a rotor segment support member comprising:
an annular body having an outer edge, an inner edge defining an opening, a first surface, and a second surface opposite the first surface, the rotor segment support member having a circumferential axis extending about the annular body and a radial axis extending between the outer edge and a center of the opening through the inner edge, the annular body having a non-uniform cross-section extending along one of the circumferential axis and the radial axis.

12. The vehicle according to claim 11, wherein the first surface extends substantially perpendicularly relative to the outer edge and the inner edge.

13. The vehicle according to claim 12, further comprising a plurality of permanent magnet (PM) members arrayed about the first surface.

14. The vehicle according to claim 13, wherein the outer edge includes a first thickness and the inner edge includes a second thickness that is less than the first thickness.

15. The vehicle according to claim 14, wherein the second surface tapers from the outer edge toward the inner edge.

16. The vehicle according to claim 13, further comprising a recess formed in the second surface, the recess extending between the outer edge and the inner edge.

17. The vehicle according to claim 16, wherein the recess includes a first width at the outer edge and a second width at the inner edge, the second width being smaller than the first width.

18. The vehicle according to claim 17, wherein the recess includes a first depth at the outer edge and a second depth at the inner edge, the first depth being greater than the second depth.

19. The vehicle according to claim 17, wherein the recess is formed in the second surface opposite each of the plurality of PM members.

20. The vehicle according to claim 11, wherein the non-uniform cross-section extends along each of the circumferential axis and the radial axis.
